(19) United States
(12) Patent Application Publication
(10) Pub. No.: US 2012/0013889 A1
(43) Pub. Date: Jan. 19, 2012

(54) Method and Device for Determining the Position of a Boundary Between Two Phased in a Sample Tube

(75) Inventor: Michael Heise, Marbach (DE)

(73) Assignee: PVT PROBENVERTEILTECHNIK GMBH, Waiblingen (DE)

(21) Appl. No.: 13/144,372

(22) PCT Filed: Dec. 17, 2009
(86) PCT No.: PCT/EP09/67364

§ 371 Date: Sep. 29, 2011

(30) Foreign Application Priority Data
Jan. 14, 2009 (DE) 10 2009 005 252.6

(51) Int. Cl. G01J 3/00; G01J 5/00

(52) U.S. Cl. 356/51

(57) ABSTRACT

A method and device are provided for determining at least one vertical position of at least one horizontally extending interface between a first component and at least one second component present in a sample tube in layers separated from one another. To this end, the device exposes the sample tube in multiplex time to light impulses having a first and a second wavelength, measures intensities of light impulses of the first and second wavelength exiting the sample tube, and analyzes the measured intensities for determining the position of the interfaces.

### BACKGROUND AND SUMMARY OF THE INVENTION

The invention relates to a method and a device for determining the position of at least one interface between components in a sample tube.

Sample tubes are used, for example, in the medical pre-analytic process. The content of the sample tube typically comprises one or more components or phases that are layered vertically in the order of their density. For example, in the case of a centrifuged blood sample, the sample tube content comprises an uppermost first component in the form of air or gas, a second component or more specifically phase in the form of blood serum, a third component or more specifically phase in the form of a synthetic separation gel and a fourth bottommost component or more specifically phase in the form of the solid components of the blood, the so-called blood clot.

Typically a number of medical analyses are conducted on the content or more specifically the components of a sample tube. Therefore, the content of the sample tube is often divided among several secondary tubes. In order to be able to carry out the distribution without any errors, the fill level of the component(s) or rather the vertical position of the interfaces or boundaries between the components has to be determined as precisely as possible, in order to prevent air from being drawn, for example, from the sample tube during extraction of the component(s) when the extraction point is selected too high, or in order to prevent the separation gel from clogging an extraction tube, when in the course of extraction the extraction tube is lowered too far into the sample tube.

There exist a plurality of methods for determining the fill level or, more specifically, the interface. For example, in the case of optical methods the phase transitions or rather interfaces between the phases or components of the sample tube content are determined by means of a scanning absorption or transmission measuring method. Such methods are based on the different absorption coefficients of the respective phases or rather components.

Such a method is disclosed in U.S. Pat. No. 6,770,883 B2. The described method determines the interfaces between different components inside a sample tube in that the sample tube is irradiated with light of a first wavelength and light of a second wavelength. The intensity of the light leaving the sample tube is detected by means of two wavelength specific receivers. In order to determine the interfaces, the received intensity portions of the first wavelength and the second wavelength are evaluated separately from each other.

The invention is based on the technical problem of providing a method and a device for determining at least one vertical position of at least one horizontally extending interface between a first component and at least one second component, both of which are present in a sample tube in layers that are separated from each other. At the same time this method and device make it possible to determine the interface in a reliable and cost-effective way.

The invention solves this problem with a method and device for determining at least one vertical position of at least one horizontally extending interface between a first component and at least one second component, both of which are present in a sample tube in layers that are separated from each other, the method comprising the acts of: (a) irradiating the sample tube with a plurality of light pulses of a first wavelength, perpendicular to the vertical axis of the sample tube at a vertical irradiation position; (b) irradiating the sample tube with a plurality of light pulses of a second wavelength, which is different from the first wavelength, perpendicular to the vertical axis of the sample tube at the vertical irradiation position, so that the sample tube is irradiated alternatingly with one of the plurality of light pulses of the first wavelength and one of the plurality of light pulses of the second wavelength; (c) measuring an intensity of the light pulses of the first and second wavelength emerging from the sample tube at the vertical irradiation position; (d) calculating an irradiation position value as a function of the measured intensity of the light pulses of the first and the second wavelengths; (e) changing the vertical irradiation position along the vertical axis and repeating the steps a) to d), until a desired vertical region is passed; and (f) evaluating the calculated irradiation position values along the vertical axis for determining the at least one vertical position of the at least one interface.

Advantageous and preferred embodiments of the invention are described and claimed herein. The claims are worded with explicit reference to the content of the specification.

The method according to the invention serves to determine at least one vertical position of at least one horizontally extending interface between a first component and at least one second component, both of which are present in a sample tube in layers that are separated from each other. The interface(s) may be, for example, an interface between liquid components, an interface between liquid components and sediment-containing components and/or an interface between liquid components and air. The method comprises the steps: a) irradiating the sample tube with light pulses of a first wavelength, perpendicular to the vertical axis of the sample tube at a vertical irradiation position, b) irradiating the sample tube with light pulses of a second wavelength, which is different from the first wavelength, perpendicular to the vertical axis of the sample tube at the vertical irradiation position, so that the sample tube is irradiated alternatingly with one of the light pulses of the first wavelength and one of the light pulses of the second wavelength, that is, the light pulses of the first wavelength and the light pulses of the second wavelength are generated so as to be imbricated or interleaved with each other or time-multiplexed, c) measuring the intensity of the light pulses of the first and second wavelength emerging from the sample tube at the vertical irradiation position, d) calculating an irradiation position value as a function of the measured intensity of the light pulses of the first and the second wavelengths, wherein the irradiation position is an irradiation position-dependent arithmetic value that is a function of the measured intensities of the light pulses of the first and the second wavelengths, e) changing the vertical irradiation position along the vertical axis and repeating the steps a) to d), until a desired vertical region is passed, and f) evaluating the calculated irradiation position values along the vertical axis for determining the vertical position of the interface.

In a further development of the method a respective irradiation position value is calculated by forming a quotient from the measured intensity of the light pulses of the first wavelength and the measured intensity of the light pulses of the second wavelength, and by comparing the formed quotient with a threshold value in order to determine the vertical position of the interface. Preferably the light pulses of the first and the second wavelengths are generated with identical intensities. Furthermore, it is self-evident that the quotient or an inverse value of the quotient can be used as the operand. The quotient is comparatively independent of a layer thickness of a sample tube material, typically transparent plastic, and a number of labels and stickers that are stuck on the sample tube. Preferably the quotient is calculated for a number of different vertical positions along the vertical axis, and the vertical position of the interface is assigned to the respective vertical position, at which the quotient exceeds or drops below the threshold value for the first time.

In a further development of the method the first and the second wavelengths are chosen in such a manner that the second wavelength is absorbed at a higher rate by the second component than the first wavelength is.

In a further development of the method the first wavelength lies in a range between 400 nm and 1,200 nm, and/or the second wavelength lies in a range between 1,300 nm and 1,700 nm.

In a further development of the method the first, the second and a third component are layered vertically in sequence in the sample tube so as to form two horizontal interfaces. In this context the calculated irradiation position values are additionally evaluated along the vertical axis for determining the vertical positions of the two interfaces.

In a further development of the method the first component is air, and the second component is blood serum. Preferably the third component is a synthetic separation gel. It is self-evident that the invention also lends itself well to determining the vertical interface positions of other components that may be contained in the sample tube. If the sample tube contains, for example, only urine, then the vertical position of the air/urine interface can be determined. Moreover, the sample tube can contain, for example, exclusively non-centrifuged blood. In this case the vertical position of the air/blood interface can be determined by means of the invention.

In a further development of the method the sample tube is irradiated with light pulses of the first wavelength and the light pulses of the second wavelength in such a manner that the light pulses of the first wavelength and the light pulses of the second wavelength follow an essentially identical light path through the sample tube.

The device according to the invention serves to determine at least one vertical position of at least one horizontally extending interface between a first component and at least one second component, both of which are present in a sample tube in layers that are separated from each other. The device is designed, in particular, for carrying out the method according to the invention. The device comprises a first light source that generates a plurality of light pulses of a first wavelength, perpendicular to a vertical axis of the sample tube at a vertical irradiation position; a second light source that generates a plurality of light pulses of a second wavelength, which is different from the first wavelength, perpendicular to the vertical axis of the sample tube at the vertical irradiation position; a light source actuating unit that is configured so as to actuate the first and the second light source in such a way that they irradiate in an alternating manner the sample tube with one of the plurality of light pulses of the first wavelength and with one of the plurality of light pulses of the second wavelength; a single light receiver for measuring the intensity of the light pulses of the first wavelength and the second wavelength emerging from the sample tube at the vertical irradiation position; an arithmetic processing unit that is coupled to the light receiver and that is designed to calculate an irradiation position value as a function of the measured intensities of the light pulses of the first and the second wavelengths; a sample tube handling unit, for example in the form of a gripper which can be moved in the X, Y and Z direction, that is configured so as to accommodate in a detachable manner the sample tube and to change the vertical irradiation position by means of a relative movement between the sample tube and the first light source and the second light source; and an evaluating unit that is configured so as to evaluate the calculated irradiation position values along the vertical axis for determining at least one vertical position of the at least one interface.

In a further development of the device the first light source emits light in a wavelength range between 400 nm and 1,200 nm, and/or the second light source emits light in a wavelength range between 1,300 and 1,700 nm. The light sources may be, for example, LEDs, laser diodes or lasers.

In a further development of the device the first light source and the second light source are configured in such a way that the sample tube is irradiated with the light pulses of the first wavelength and the light pulses of the second wavelength in such a way that the light pulses of the first wavelength and the light pulses of the second wavelength follow an essentially identical light path through the sample tube.

Embodiments of the invention are shown in the accompanying drawings in the form of graphs and are explained in detail below.

### BRIEF DESCRIPTION OF THE DRAWINGS

FIG. 1 shows the absorption spectra of blood serum, plastic and paper;

FIG. 2 shows the intensity profiles of light pulses with a first wavelength and a second wavelength, both of which are irradiated into a sample tube, and the associated measured intensity profiles of light pulses emerging from the sample tube under different conditions;

FIG. 3 shows the inventive device for determining the interface position; and

FIG. 4 shows the profile of the measured average intensity values of the light pulses with the first wavelength and the second wavelength, both of which emerge from the sample tube, and a quotient signal, which is formed from the measured average intensity values of the first and the second wavelengths, along a vertical axis of the sample tube.

### DETAILED DESCRIPTION OF THE DRAWINGS

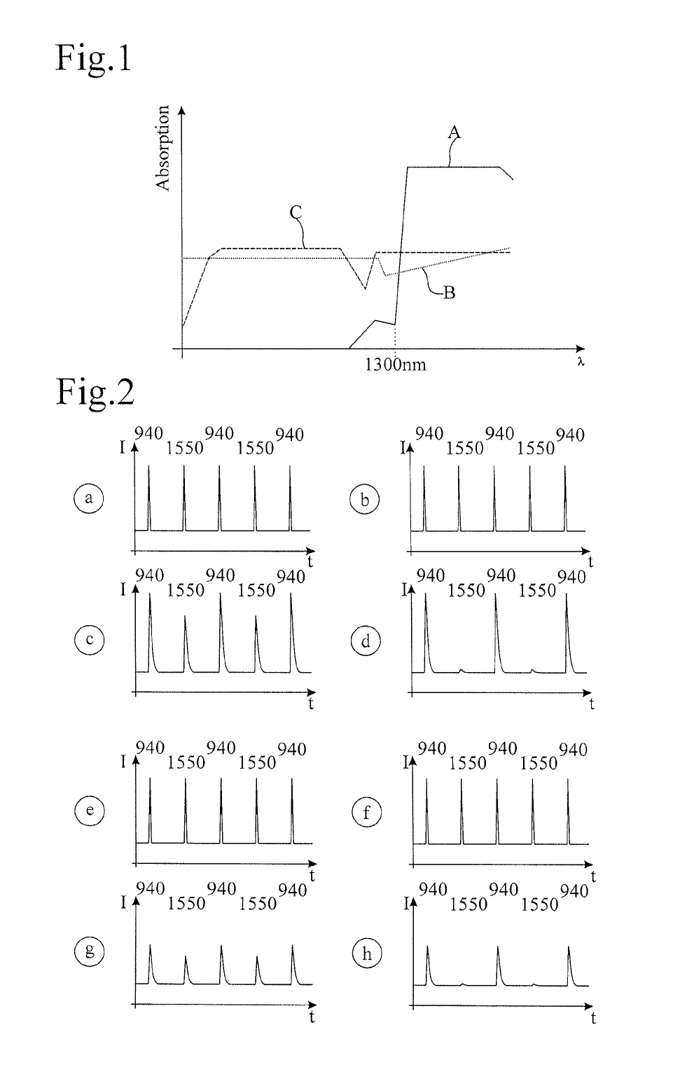

FIG. 1 shows the absorption spectra of typical materials in the light path when a sample tube is irradiated. The materials are water or blood serum (spectrum A), plastic (spectrum B), that is, the typically used sample tube material, and paper (spectrum C), of which the labels and stickers are usually made and which are stuck on the sample tube for identification.

Blood serum, the absorption spectrum of which corresponds in essence to that of water due to its high water content, absorbs virtually all of the light above a wavelength of approximately 1,300 nm, whereas it absorbs virtually no light below approximately 1,200 nm. The other materials that are in the light path absorb uniformly the whole wavelength range between 400 nm and 1,600 nm more or less independently of the wavelength. The degree of absorption is practically solely dependent on the layer thickness of the materials in the light path.

FIG. 2 shows the variation over time of an intensity I of a plurality of light pulses with a first wavelength of 940 nm and a plurality of light pulses with a second wavelength of 1,550 nm, with which a sample tube is irradiated, and the associated measured intensity profiles of light pulses, emerging from a sample tube, under different conditions.

The subdiagrams a, b, e, and f of FIG. 2 show in each case the transmitted light pulses of different wavelengths. As shown, the sample tube is irradiated in an alternating manner with one of the plurality of light pulses of the first wavelength and one of the plurality of light pulses of the second wavelength.

That is, the light pulses of the first wavelength and the light pulses of the second wavelength are interleaved within the illustrated irradiation time interval or more specifically are generated time-multiplexed and emitted. The intensity of the transmitted pulses remains constant in the irradiation time interval. In this case the pulses of the first and the second wavelengths can be generated with an identical or different intensity. Preferably the pulses of the first and the second wavelengths have an identical intensity. In order to determine the interface, the irradiated intensities, that is, the intensities of the transmitted pulses of the first and the second wavelengths, do not have to be absolutely known. It suffices to equalize, for example, by way of calculation the two irradiated intensities at the start of the interface determining operation. Forming the quotient cancels out the unknown, but identical intensities.

The subdiagrams c and d from FIG. 2 show the measured intensity profiles of light pulses emerging from a sample tube, when a single label is in the light path. Subdiagram c shows the signals for an empty sample tube or more specifically a sample tube filled with air, and subdiagram d shows the signals for a sample tube that is filled with water or blood serum. As apparent from the diagrams, the pulses with the second wavelength are almost totally absorbed by water and/or the blood serum.

The subdiagrams g and h from FIG. 2 show the measured intensity profiles of light pulses emerging from the sample tube, when two labels are in the light path. Subdiagram g shows the signals for an empty sample tube or more specifically a sample tube filled with air, and subdiagram h shows the signals for a sample tube that is filled with water or blood serum. A comparison of the diagrams c, d and g, h shows that the degree of absorption for the first wavelength is practically only a function of the number of labels, that is, the layer thickness of the materials in the light path.

Therefore, the measured intensity of the first wavelength can serve to standardize or rather normalize, that is, to form the denominator of the fraction when forming the quotient of the intensities of the pulses of the first and the second wavelengths.

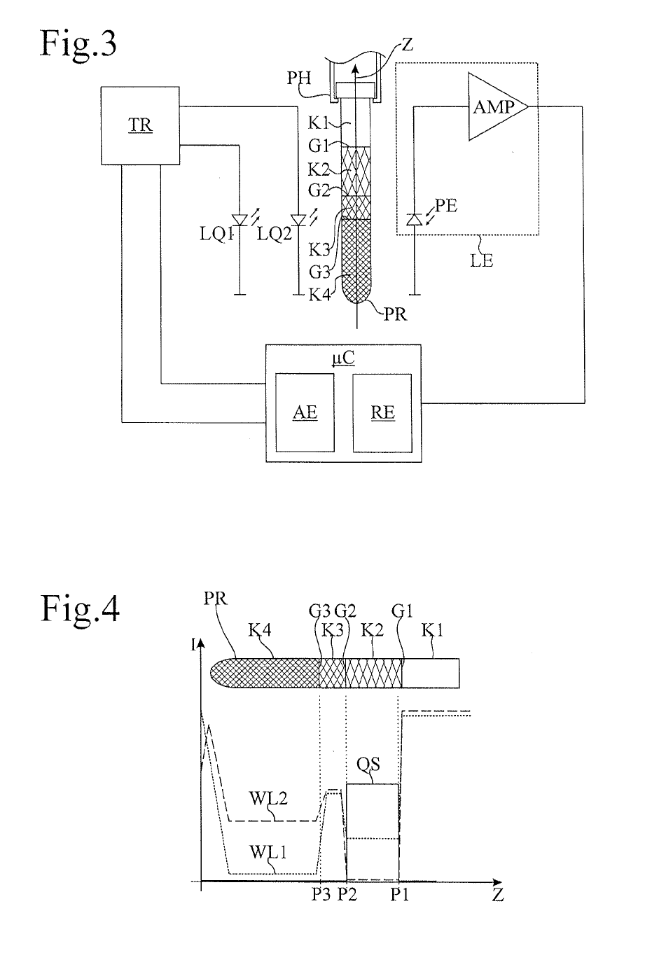

FIG. 3 shows an inventive device for determining the vertical position of an interface. The device serves to determine a vertical position P1 (see FIG. 4) of a first horizontally extending interface G1 between a first component in the form of air K1 and a second component in the form of blood serum K2 and to determine a vertical position P2 (see FIG. 4) of a second horizontally extending interface G2 between the second component K2 and a third component in the form of a separation gel K3. In this case the components K1 to K3 are present in a sample tube PR in layers that are separated from each other. Furthermore, the sample tube PR contains as the bottommost component or rather layer a so-called blood clot K4. In principle, the vertical position of the interface G3 between the components K3 and K4 can also be determined by the device, but does not have to be absolutely mandatory.

The device comprises a first light source LQ1 in the form of one or more LEDs that, when properly actuated, generate a plurality of light pulses of a first wavelength of 940 nm, perpendicular to a vertical axis Z of the sample tube PR at a vertical irradiation position, and a second light source LQ2 in the form of one or more LEDs that, when properly actuated, generate a plurality of light pulses of a second wavelength of 1,550 nm, perpendicular to the vertical axis Z of the sample tube PR at the vertical irradiation position. It is possible to provide suitable light conducting and light collecting means for conducting, collecting and/or focusing the radiated and/or received light.

Furthermore, there is a light source actuating unit AE that is configured so as to actuate the first and the second light source LQ1 and LQ2 in such a way that they irradiate in an alternating manner the sample tube PR with one of a plurality of light pulses of the first wavelength and with one of a plurality of light pulses of the second wavelength (see, for example, FIG. 2, subdiagrams a, b, e and f). Between the light source actuating unit AE and the light sources LQ1 and LQ2 there is also a driver TR, which generates the necessary signal level for actuating the light sources LQ1 and LQ2 from the actuating signals of the light source actuating unit AE.

A single light receiver LE serves to measure the intensity of the light pulses of the first wavelength and the second wavelength emerging from the sample tube PR at the vertical irradiation position. In this case an InGaAs [Indium—Gallium—Arsenide] sensor PE can be used as the light receiver LE that can be operated starting at approximately 850 nm. In order to be able to compensate for the typically low sensitivity in the bottom wavelength range of such sensors, a plurality of transmitting diodes can be used in the first light source LQ1 at 940 nm. In order to collect the signals to be received, a parabolic mirror (not illustrated) can be used. In order to be able to condition the signals generated by the sensor PE, these signals can be amplified by means of a multi-step measuring amplifier AMP. In order to be able to quickly adjust the gain, one of the output stages of the amplifier is selected as the amplified signal as a function of the available signal level. This signal in turn is sent by the multi-step measuring amplifier AMP for further conditioning in an arithmetic processing unit RE.

The arithmetic processing unit RE is coupled to the light receiver LE or more specifically to the active output of the measuring amplifier AMP and is configured so as to calculate an irradiation position value as a function of the measured intensities of the light pulses of the first and the second wavelengths.

An irradiation position value is calculated by forming a quotient from the average measured intensity of the light pulses of the first wavelength and the average measured intensity of the light pulses of the second wavelength.

A sample tube handling unit PH is configured so as to accommodate in a detachable manner the sample tube PR and to change the vertical irradiation position by means of a relative movement between the sample tube PR and the first light source LQ1 and the second light source LQ2. In the present case the light sources LQ1 and LQ2 are securely mounted, and the sample tube handling unit PH lowers the sample tube PR vertically in order to determine the position of the interface, thus moving the sample tube PR past the light sources LQ1 and LQ2 in the Z direction.

An evaluating unit in the form of a microprocessor μC is configured so as to evaluate the calculated irradiation position values along the vertical axis Z for determining the vertical positions P1 and P2 of the interfaces G1 and G2. The actuating unit AE and the arithmetic processing unit RE are integrated into the microprocessor μC.

The process of determining the vertical positions P1 and P2 of the interfaces G1 and G2 is described below with reference to FIG. 4.

FIG. 4 shows the profile of a measured average intensity value WL1 of light pulses with the first wavelength and the profile of a measured average intensity value WL2 of light pulses with the second wavelength, emerging from the sample tube, and a quotient signal QS, which is formed from the measured average intensity values of the first and the second wavelengths, along the vertical axis Z of the sample tube PR.

In order to generate the signal profiles shown in FIG. 4, the sample tube PR is lowered continuously or in steps slowly into the region of the light sources LQ1 and LQ2 and the receiver LE. A continuous lowering is possible, because the rate of descent is less than the rate at which the signal is generated and evaluated.

The sample tube PR is irradiated with a plurality of light pulses of the first and the second wavelength, both of which are interleaved with each other, vertically to the axis Z at a vertical irradiation position. The intensity of the light pulses of the first and second wavelength emerging from the sample tube PR is measured at the vertical irradiation position. Then an irradiation position value is calculated as a function of the measured intensity of the light pulses of the first and the second wavelengths. An irradiation position value is calculated by forming a quotient from the measured average intensity of the light pulses of the first wavelength and the measured average intensity of the light pulses of the second wavelength.

The sample tube is lowered even further, thus changing the vertical irradiation position until a desired vertical region has been passed. The above-described steps are repeated for the changed vertical irradiation position. That is, the irradiation position-dependent irradiation position value is formed as the quotient from the measured average intensity of the light pulses of the first wavelength and the measured average intensity of the light pulses of the second wavelength.

The irradiation position value or rather quotient is compared with a threshold value for each assigned position.

In the case that the quotient exceeds the threshold value, the quotient threshold value signal QS is assigned the logical value “1”, and in the case that the quotient falls below the threshold value, the quotient threshold value signal QS is assigned the logical value “0”.

Consequently the quotient threshold value signal QS has a logical value 1 only for those vertical regions of the sample tube that contain the blood serum K2. The evaluation and/or calculation of the quotient threshold value signal QS can also be backed up by filtering the measured values and plausibility checking.

As a result, the vertical positions P1 and P2 of the interfaces G1 and G2 can be detected with a high degree of reliability, so that it is possible to divide reliably the blood serum K2 of the sample tube PR among several secondary tubes, because there is no risk that air K1 will be drawn from the sample tube in the course of extracting the blood serum, when the extraction position is chosen too high, or that the separation gel K3 will clog an extraction tube, when the extraction tube is lowered too far into the sample tube during the extraction operation.

1-12. (canceled)

13. A method for determining at least one vertical position of at least one horizontally extending interface between a first component and at least one second component, both of which are present in a sample tube in layers that are separated from each other, the method comprising the acts of:
a) irradiating the sample tube with a plurality of light pulses of a first wavelength, perpendicular to the vertical axis of the sample tube at a vertical irradiation position;
b) irradiating the sample tube with a plurality of light pulses of a second wavelength, which is different from the first wavelength, perpendicular to the vertical axis of the sample tube at the vertical irradiation position, so that the sample tube is irradiated alternatingly with one of the plurality of light pulses of the first wavelength and one of the plurality of light pulses of the second wavelength;
c) measuring an intensity of the light pulses of the first and second wavelength emerging from the sample tube at the vertical irradiation position;
d) calculating an irradiation position value as a function of the measured intensity of the light pulses of the first and the second wavelengths;
e) changing the vertical irradiation position along the vertical axis and repeating the steps a) to d), until a desired vertical region is passed; and
f) evaluating the calculated irradiation position values along the vertical axis for determining the at least one vertical position of the at least one interface.

14. The method according to claim 13, wherein:
a respective irradiation position value is calculated by forming a quotient from the measured intensity of the light pulses of the first wavelength and the measured intensity of the light pulses of the second wavelength; and
comparing the formed quotient with the threshold value in order to determine at least one vertical position of at least one interface.

15. The method according to claim 14, wherein:
the quotient is calculated for a number of different vertical positions along the vertical axis; and
the vertical position of at least one interface is assigned to the respective vertical position, at which the quotient exceeds or drops below the threshold value for the first time.

16. The method according to claim 13, wherein the first and the second wavelengths are chosen such that the second wavelength is absorbed at a higher rate by the second component than is the first wavelength.

17. The method according to claim 13, wherein at least one of the first wavelength lies in a range between 400 nm and 1,200 nm, and the second wavelength lies in a range between 1,300 nm and 1,700 nm.

18. The method according to claim 16, wherein at least one of the first wavelength lies in a range between 400 nm and 1,200 nm, and the second wavelength lies in a range between 1,300 nm and 1,700 nm.

19. The method according to claim 13, wherein the first, the second and a third component are layered vertically in an order of sequence in the sample tube so as to form two horizontal interfaces, and further wherein the calculated irradiation position values are additionally evaluated along the vertical axis for determining the vertical positions of the two horizontal interfaces.

20. The method according to claim 13, wherein the first component is air, and the second component is blood serum.

21. The method according to claim 19, wherein the first component is air, and the second component is blood serum.

22. The method according to claim 21, wherein the third component is a separation gel.

23. The method according to claim 19, wherein the third component is a separation gel.

24. The method according to claim 13, wherein the sample tube is irradiated with the light pulses of the first wavelength and the light pulses of the second wavelength such that the light pulses of the first wavelength and the light pulses of the second wavelength follow an essentially identical light path through the sample tube.

25. The method according to claim 14, wherein the sample tube is irradiated with the light pulses of the first wavelength and the light pulses of the second wavelength such that the light pulses of the first wavelength and the light pulses of the second wavelength follow an essentially identical light path through the sample tube.

26. The method according to claim 15, wherein the sample tube is irradiated with the light pulses of the first wavelength and the light pulses of the second wavelength such that the light pulses of the first wavelength and the light pulses of the second wavelength follow an essentially identical light path through the sample tube.

27. A device for determining at least one vertical position of at least one horizontally extending interface between a first component and at least one second component, both of which are present in a sample tube in layers that are separated from each other, said device comprising:
a first light source that generates a plurality of light pulses of a first wavelength, perpendicular to a vertical axis of the sample tube at a vertical irradiation position;
a second light source that generates a plurality of light pulses of a second wavelength, which is different from the first wavelength, perpendicular to the vertical axis of the sample tube at the vertical irradiation position;
a light source actuating unit that is configured so as to actuate the first and the second light source such that they irradiate in an alternating manner the sample tube with one of the plurality of light pulses of the first wavelength and with one of the plurality of light pulses of the second wavelength;
a single light receiver for measuring an intensity of the light pulses of the first wavelength and the second wavelength emerging from the sample tube at the vertical irradiation position;
an arithmetic processing unit that is coupled to the light receiver and that calculates an irradiation position value as a function of the measured intensities of the light pulses of the first and the second wavelengths;
a sample tube handling unit that is configured so as to accommodate in a detachable manner the sample tube and to change the vertical irradiation position via a relative movement between the sample tube and the first light source and the second light source; and
an evaluating unit that is configured so as to evaluate the calculated irradiation position values along the vertical axis for determining at least one vertical position of the at least one interface.

28. The device according to claim 27, wherein at least one of the first light source emits light in a wavelength range between 400 nm and 1,200 nm, and the second light source emits light in a wavelength range between 1,300 nm and 1,700 nm.

29. The device according to claim 27, wherein the first light source and the second light source are configured such that the sample tube is irradiated with the light pulses of the first wavelength and the light pulses of the second wavelength such that the light pulses of the first wavelength and the light pulses of the second wavelength follow an essentially identical light path through the sample tube.

30. The device according to claim 28, wherein the first light source and the second light source are configured such that the sample tube is irradiated with the light pulses of the first wavelength and the light pulses of the second wavelength such that the light pulses of the first wavelength and the light pulses of the second wavelength follow an essentially identical light path through the sample tube.
